(19) United States
(12) Patent Application Publication
(10) Pub. No.: US 2026/0275137 A1
(43) Pub. Date: Sep. 17, 2026

(54) Radiation-Curable Ink Jet Ink Composition

(71) Applicant: SEIKO EPSON CORPORATION, Tokyo (JP)

(72) Inventors: Emi TAKEUCHI, Shiojiri (JP); Chigusa SATO, Matsumoto (JP)

(21) Appl. No.: 19/398,524

(22) Filed: Nov. 24, 2025

(30) Foreign Application Priority Data
Nov. 25, 2024 (JP) 2024-204733

(51) Int. Cl. C09D 11/38; C09D 11/326

(52) U.S. Cl. CPC C09D 11/38; C09D 11/326

(57) ABSTRACT

A radiation-curable ink jet ink composition includes trifunctional or higher polyfunctional monomers and 5-methyl-3-vinyloxazolidin-2-one, in which a content of the 5-methyl-3-vinyloxazolidin-2-one is less than 50% by mass with respect to a total amount of the radiation-curable ink jet ink composition, a content of monofunctional monomers is 60% by mass or more with respect to a total amount of polymerizable compounds, and a content of the trifunctional or higher polyfunctional monomers is more than 1% by mass with respect to the total amount of the radiation-curable ink jet ink composition.

The present application is based on, and claims priority from JP Application Serial Number 2024-204733, filed Nov. 25, 2024, the disclosure of which is hereby incorporated by reference herein in its entirety.

### BACKGROUND

### 1. Technical Field

The present disclosure relates to a radiation-curable ink jet ink composition.

### 2. Related Art

Ink jet recording methods can record high-definition images using a relatively simple apparatus, and achieve rapid development in various fields. Among those, various studies have been conducted on the improvement of various characteristics. For example, JP-A-2021-042322 describes a radiation-curable ink jet composition including monofunctional (meth)acrylate monomers and vinyl methyl oxazolidinone, with an object of providing a radiation-curable ink jet composition that can form a coating film having low viscosity and excellent stretchability.

Studies have been conducted to improve the curability, adhesion, and the like of a recorded material, including the ink jet composition described in JP-A-2021-042322.

### SUMMARY

A radiation-curable ink jet composition of the present disclosure is a radiation-curable ink jet ink composition including trifunctional or higher polyfunctional monomers and 5-methyl-3-vinyloxazolidin-2-one, in which a content of the 5-methyl-3-vinyloxazolidin-2-one is less than 50% by mass with respect to a total amount of the radiation-curable ink jet ink composition, a content of monofunctional monomers is 60% by mass or more with respect to a total amount of polymerizable compounds, and a content of the trifunctional or higher polyfunctional monomers is more than 1% by mass with respect to the total amount of the radiation-curable ink jet ink composition.

A recording method of the present disclosure includes discharging the radiation-curable ink jet ink composition from an ink jet head to attach the radiation-curable ink jet ink composition to a shrink film or a flexible packaging film, and irradiating, with radiation, the radiation-curable ink jet ink composition attached.

### BRIEF DESCRIPTION OF THE DRAWINGS

FIG. 1 illustrates an example of a recording apparatus used in the present embodiment.

FIG. 2 is Table 1 illustrating the composition and the evaluation results of the radiation-curable ink jet ink composition used in Examples.

FIG. 3 is Table 2 illustrating the composition and the evaluation results of the radiation-curable ink jet ink composition used in Examples.

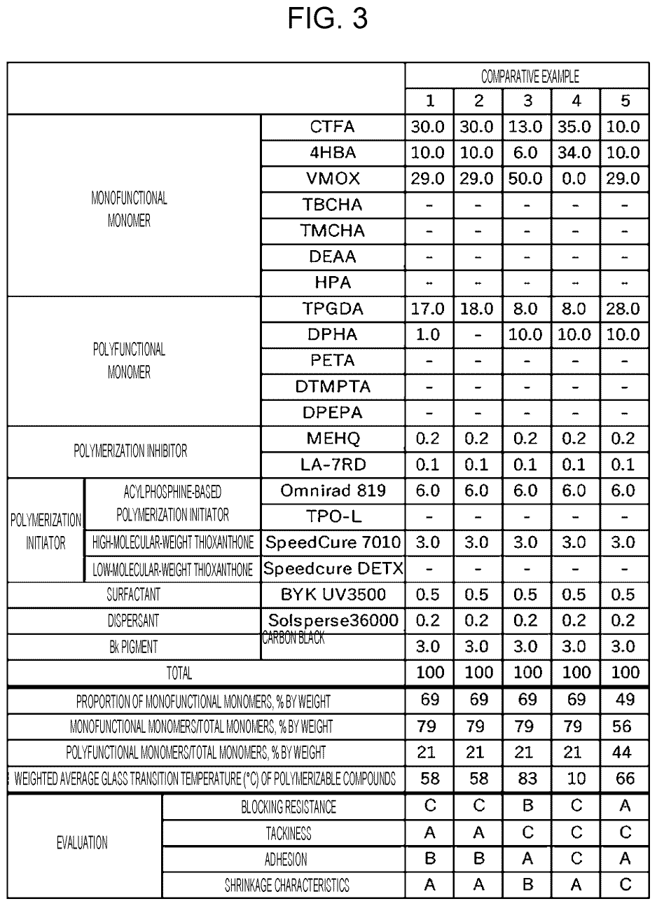

### DESCRIPTION OF EMBODIMENTS

Hereinafter, an embodiment of the present disclosure (hereinafter referred to as “the present embodiment”) will be described in detail with reference to drawings as necessary. However, the present disclosure is not limited thereto and can be variously modified without deviating from the scope of the present disclosure.

### 1. Radiation-Curable Ink Jet Ink Composition

The radiation-curable ink jet ink composition of the present embodiment (hereinafter also referred to as an “ink composition”) includes trifunctional or higher polyfunctional monomers and 5-methyl-3-vinyloxazolidin-2-one, in which a content of the 5-methyl-3-vinyloxazolidin-2-one is less than 50% by mass with respect to a total amount of the ink composition, a content of monofunctional monomers is 60% by mass or more with respect to a total amount of polymerizable compounds, and a content of the trifunctional or higher polyfunctional monomers is more than 1% by mass with respect to the total amount of the ink composition.

The ink composition suitable for a shrink film and a flexible packaging film needs to include a large amount of monofunctional monomers since the coating film is required to have flexibility. However, the radiation-curable ink composition including a large amount of monofunctional monomers tends to have low curability. When the curability is insufficient, a blocking phenomenon, in which the coating film is peeled off when the coating film and the medium overlap, and adheres to the medium, is likely to occur.

Here, it is considered to use 5-methyl-3-vinyloxazolidin-2-one (hereinafter also referred to as “VMOX”), which can have excellent curability. However, since the vinyl monomers contribute to the improvement of curability when used in combination with acrylic monomers, the improvement of curability reaches a limit even when VMOX is used in excess.

Therefore, in the present embodiment, from the viewpoint of flexibility, in the ink composition including a predetermined amount of monofunctional monomers, a predetermined amount of trifunctional or higher polyfunctional monomers is used in addition to a predetermined amount of VMOX. By using VMOX and the trifunctional or higher polyfunctional monomers in combination in this manner, the curability of the surface and the interior of the coating film can be further improved. By improving the curability of the surface, the tackiness of the ink coating film can be reduced, and by improving the curability of the interior, blocking can be suppressed. In particular, VMOX contributes to surface curability, and the trifunctional or higher polyfunctional monomers can contribute to the improvement of curability of the interior of the coating film by introducing a crosslinking point.

The radiation-curable ink jet composition of the present embodiment is cured by irradiation with radiation. Examples of the radiation include ultraviolet rays, electron beams, infrared rays, visible light, and X-rays. As the radiation, the ultraviolet rays are preferable from the viewpoint that a radiation source is easily obtained and widely used and the viewpoint that a material suitable for curing by radiation with ultraviolet rays is easily obtained and widely used.

Hereinafter, each of the components included in the radiation-curable ink jet composition in the present embodiment will be described in detail.

### 1.1. Polymerizable Compounds

In the present embodiment, compounds that are cured by irradiation with radiation are collectively referred to as polymerizable compounds. Examples of the polymerizable compounds in the present embodiment include monofunctional monomers having one polymerizable functional group and polyfunctional monomers having two or more polymerizable functional groups. In addition, the polyfunctional monomers include bifunctional monomers having two polymerizable functional groups, and trifunctional or higher polyfunctional monomers having three or more polymerizable functional groups. In the present embodiment, the polyfunctional monomers do not include oligomers.

In the present embodiment, the oligomer refers to a polymeric substance having a polymerizable compound as a constituent component, in which the oligomer is a compound having one or more polymerizable functional groups. In the present embodiment, a compound having a molecular weight of 1,000 or more is defined as an oligomer, and a compound having a molecular weight of less than 1,000 is defined as a monomer.

The weighted average glass transition temperature of the polymerizable compounds is preferably 30° C. or higher and 70° C. or lower, more preferably 40° C. or higher and 65° C. or lower, and still more preferably 50° C. or higher and 60° C. or lower. When the weighted average glass transition temperature is 30° C. or higher, the adhesion of the ink composition tends to be further improved, and when the weighted average glass transition temperature is 70° C. or lower, the shrinkage characteristics tend to be further improved. Furthermore, in the present specification, the glass transition temperature can be measured, for example, by a differential scanning calorimeter.

When a difference between the highest glass transition temperature and the lowest glass transition temperature among the glass transition temperatures of homopolymers of the monofunctional monomers is defined as a difference A [° C.], and a difference between the highest glass transition temperature and the lowest glass transition temperature among the glass transition temperatures of homopolymers of bifunctional monomers and trifunctional or higher polyfunctional monomers is defined as a difference B [° C.], it is preferable that the difference A is larger than the difference B. The glass transition temperature of the ink composition needs to be adjusted to an appropriate value by adjusting the types and contents of the polymerizable compounds. However, since the monofunctional monomers have a large content, they make a significant contribution to the glass transition temperature of the ink composition. Therefore, the difference A being larger than the difference B makes it easier to adjust the glass transition temperature of the ink composition. As a result, the degree of freedom in the design of the ink composition is increased, making it easier to realize the ink characteristics according to the purpose.

### 1.1.1. Monofunctional Monomers

The ink composition of the present embodiment includes 5-methyl-3-vinyloxazolidin-2-one (VMOX) as one monofunctional monomer. VMOX refers to a compound represented by the following chemical formula.

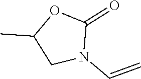

VMOX has low viscosity, as compared with other N-vinyl compounds, making it suitable for an ink jet ink composition since the viscosity of the composition is less likely to increase. In addition, VMOX can also improve the adhesion and tackiness of the coating film. A commercially available product of VMOX can be obtained from BASF, for example.

In addition, the ink composition of the present embodiment may include monofunctional monomers other than VMOX. The monofunctional monomers other than VMOX are not particularly limited, but examples thereof include nitrogen-containing monofunctional monomers, alicyclic group-containing monofunctional monomers, aliphatic group-containing monofunctional monomers, aromatic group-containing monofunctional monomers, ether cyclic monofunctional monomers, and monofunctional monomers having a hydroxyl group. These monofunctional monomers are used alone or in combination of two or more kinds thereof.

The total content of the monofunctional monomers is 60% by mass or more, preferably 63% by mass or more and 99% by mass or less, more preferably 70% by mass or more and 90% by mass or less, and still more preferably 75% by mass or more and 88% by mass or less with respect to the total amount of the polymerizable compounds. By setting the content of the monofunctional monomers within the range, the flexibility tends to be further improved and the adhesion and shrinkage characteristics tend to be further improved, and therefore, the ink composition is more suitable for a shrink film and a flexible packaging film.

The total content of the monofunctional monomers is preferably 63% by mass or more and 90% by mass or less, more preferably 65% by mass or more and 88% by mass or less, and still more preferably 67% by mass or more and 87% by mass or less with respect to the total amount of the ink composition. By setting the content of the monofunctional monomers within the range, the tackiness, the adhesion, and the shrinkage characteristics tend to be further improved.

### 1.1.1.1. VMOX

The ink composition of the present embodiment can improve the tackiness and the adhesion by using 5-methyl-3-vinyloxazolidin-2-one (VMOX). In addition, the viscosity of the ink can also be set to a suitable range.

The content of VMOX is less than 50% by mass, preferably 49% by mass or less, more preferably 40% by mass or less, and still more preferably 35% by mass or less with respect to the total amount of the ink composition. VMOX, which is a vinyl monomer, tends to exhibit superior tackiness by reacting with an acrylic monomer. In this regard, by setting the content of VMOX within the range, the monomers other than VMOX, for example, the acrylic monomer are relatively more included, and therefore, the tackiness tends to be further improved. In addition, the content of VMOX is preferably 10% by mass or more, more preferably 20% by mass or more, and still more preferably 25% by mass or more with respect to the total amount of the ink composition. By setting the content of VMOX within the range, the tackiness, the adhesion, and the shrinkage characteristics tend to be further improved.

1.1.1.2. Nitrogen-Containing Monofunctional Monomers Other than VMOX

The nitrogen-containing monofunctional monomers other than VMOX are not particularly limited, but examples thereof include nitrogen-containing monofunctional vinyl monomers such as N-vinylcaprolactam, N-vinylformamide, N-vinylcarbazole, N-vinylacetamide, and N-vinylpyrrolidone; nitrogen-containing monofunctional acrylate monomers such as acryloylmorpholine; and nitrogen-containing monofunctional acrylamide monomers, such as (meth)acrylamides such as (meth)acrylamide, N-hydroxymethyl (meth)acrylamide, diacetone acrylamide, N,N-dimethyl (meth)acrylamide, N,N-diethyl acrylamide, and a dimethylaminoethyl acrylate benzyl chloride quaternary salt.

The content of the nitrogen-containing monofunctional monomers other than VMOX is preferably 1% by mass or more and 60% by mass or less, more preferably 10% by mass or more and 50% by mass or less, still more preferably 20% by mass or more and 40% by mass or less, and even still more preferably 25% by mass or more and 35% by mass or less with respect to the total amount of the ink composition. By setting the content of the nitrogen-containing monofunctional monomers other than VMOX within the range, the tackiness, the adhesion, and the shrinkage characteristics tend to be further improved.

### 1.1.1.3. Alicyclic Group-Containing Monofunctional Monomers

The alicyclic group-containing monofunctional monomers are not particularly limited as long as they are monomers having one or more saturated or unsaturated carbon rings that do not have aromaticity, but examples of the alicyclic group-containing monofunctional monomers include monomers having a monocyclic hydrocarbon group, such as 4-tert-butylcyclohexyl acrylate, 3,3,5-trimethylcyclohexyl acrylate, and 2-(meth)acrylic acid-1,4-dioxaspiro[4,5]dec-2-ylmethyl; monomers having an unsaturated polycyclic hydrocarbon group, such as dicyclopentenyl acrylate and dicyclopentenyloxyethyl acrylate; and monomers having a saturated polycyclic hydrocarbon group, such as dicyclopentanyl acrylate and isobornyl acrylate (IBXA).

The content of the alicyclic group-containing monofunctional monomers is preferably 1% by mass or more and 60% by mass or less, more preferably 10% by mass or more and 50% by mass or less, still more preferably 20% by mass or more and 40% by mass or less, and even still more preferably 25% by mass or more and 35% by mass or less with respect to the total amount of the ink composition. By setting the content of the alicyclic group-containing monofunctional monomers within the range, the tackiness, the adhesion, and the shrinkage characteristics tend to be further improved.

### 1.1.1.4. Ether Cyclic Monofunctional Monomers

The ink composition in the present embodiment preferably includes ether cyclic monofunctional monomers. By configuring the ink composition to include the ether cyclic monofunctional monomers, the adhesion, tackiness, and shrinkage characteristics tend to be further improved. The ether cyclic monofunctional monomers are not particularly limited as long as they include a cyclic ether skeleton such as tetrahydrofuran and tetrahydropyran, but examples thereof include cyclic trimethylolpropane formal (meth)acrylate and tetrahydrofurfuryl (meth)acrylate.

The content of the ether cyclic monofunctional monomers is preferably 1% by mass or more and 60% by mass or less, more preferably 10% by mass or more and 50% by mass or less, still more preferably 20% by mass or more and 40% by mass or less, and even still more preferably 25% by mass or more and 35% by mass or less with respect to the total amount of the ink composition. By setting the content of the ether cyclic monofunctional monomers within the range, the tackiness, the adhesion, and the shrinkage characteristics tend to be further improved.

### 1.1.1.5. Monofunctional Monomers Having Hydroxyl Group

The ink composition in the present embodiment preferably includes monofunctional monomers having a hydroxyl group. By configuring the ink composition to include the monofunctional monomers having a hydroxyl group, the adhesion, tackiness, and shrinkage characteristics tend to be further improved. The hydroxyl group-containing monofunctional monomers are not particularly limited, but examples thereof include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, ethylene glycol monovinyl ether, diethylene glycol monovinyl ether, and 2-(meth)acryloyloxy-2-hydroxypropyl phthalate.

The content of the monofunctional monomers having a hydroxyl group is preferably 1% by mass or more and 30% by mass or less, more preferably 3% by mass or more and 20% by mass or less, and still more preferably 5% by mass or more and 15% by mass or less with respect to the total amount of the ink composition. By setting the content of the monofunctional monomers having a hydroxyl group within the range, the tackiness, the adhesion, and the shrinkage characteristics tend to be further improved.

### 1.1.2. Polyfunctional Monomers

The content of the polyfunctional monomers is preferably 1% by mass or more and 40% by mass or less, more preferably 5% by mass or more and 35% by mass or less, still more preferably 10% by mass or more and 30% by mass or less, and even still more preferably 15% by mass or more and 25% by mass or less with respect to the total amount of the polymerizable compounds. By setting the content of the polyfunctional monomers within the range, the blocking resistance, the adhesion, and the shrinkage characteristics tend to be further improved.

The content of the polyfunctional monomers is preferably 1% by mass or more and 50% by mass or less, more preferably 5% by mass or more and 40% by mass or less, still more preferably 10% by mass or more and 30% by mass or less, and even still preferably 15% by mass or more and 25% by mass or less with respect to the total amount of the ink composition. By setting the content of the polyfunctional monomers within the range, the blocking resistance, the adhesion, and the shrinkage characteristics tend to be further improved.

### 1.1.2.1. Bifunctional Monomers

The bifunctional monomers are not particularly limited, but examples thereof include vinyl ether group-containing (meth)acrylates and bifunctional (meth)acrylates.

The bifunctional (meth)acrylates are not particularly limited, but examples thereof include ethylene glycol di(meth)acrylate, diethylene glycol di(meth)acrylate, triethylene glycol di(meth)acrylate, tetraethylene glycol di(meth)acrylate, tripropylene glycol di(meth)acrylate, 1,4-butanediol di(meth)acrylate, dicyclopentanyl di(meth)acrylate, neopentyl glycol di(meth)acrylate, 1,9-nonanediol di(meth)acrylate, polyethylene glycol di(meth)acrylate, polypropylene glycol di(meth)acrylate, 1,6-hexanediol di(meth)acrylate, 2-hydroxy-1,3-di(meth)acryloxypropane, and 2-(2-vinyloxyethoxy)ethyl acrylate. These bifunctional monomers are used alone or in combination of two or more kinds thereof.

The content of the bifunctional monomers is preferably 1% by mass or more and 39% by mass or less, more preferably 5% by mass or more and 33% by mass or less, still more preferably 7% by mass or more and 25% by mass or less, and even still more preferably 10% by mass or more and 20% by mass or less with respect to the total amount of the ink composition. By setting the content of the bifunctional monomers within the range, the blocking resistance, the adhesion, and the shrinkage characteristics are improved.

The content of the bifunctional monomers is preferably 1% by mass or more and 39% by mass or less, more preferably 5% by mass or more and 35% by mass or less, still more preferably 10% by mass or more and 25% by mass or less, and even still more preferably 12% by mass or more and 20% by mass or less with respect to the total amount of the polymerizable compounds. By setting the content of the bifunctional monomers within the range, the blocking resistance, the adhesion, and the shrinkage characteristics are improved.

### 1.1.2.2. Trifunctional or Higher Polyfunctional Monomers

The ink composition in the present embodiment includes trifunctional or higher polyfunctional monomers. By configuring the ink composition to include trifunctional or higher polyfunctional monomers, the crosslinking point is introduced and the curability of the interior of the coating film is improved, and therefore, the blocking resistance is improved.

The trifunctional or higher polyfunctional monomers are not particularly limited, but examples thereof include trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxytri(meth)acrylate, pentaerythritol ethoxytetra(meth)acrylate, and dipentaerythritol penta(meth)acrylate. Among these, dipentaerythritol hexaacrylate, pentaerythritol triacrylate, ditrimethylolpropane tetraacrylate, and dipentaerythritol pentaacrylate are preferable. By using these trifunctional or higher polyfunctional monomers, the blocking resistance, the adhesion, and the shrinkage characteristics tend to be further improved. These trifunctional or higher polyfunctional monomers are used alone or in combination of two or more kinds thereof.

The trifunctional or higher polyfunctional monomer preferably has three or more acrylic groups. By using such polyfunctional monomers, the blocking resistance tends to be further improved. Examples of the polyfunctional monomers having three or more acrylic groups include trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxytri(meth)acrylate, pentaerythritol ethoxytetra(meth)acrylate, and dipentaerythritol penta(meth)acrylate.

In the present embodiment, the acrylic equivalent of the trifunctional or higher polyfunctional monomers is preferably 110 g/eq or less, more preferably 106 g/eq or less, still more preferably 100 g/eq or less, and even still preferably 98 g/eq or less. By setting the acrylic equivalent within the range, the blocking resistance tends to be further improved. Furthermore, the acrylic equivalent is calculated by the following calculation expression. (Acrylic equivalent)=(Molecular weight of monomer/Number of acrylic groups in monomer)

The content of the trifunctional or higher polyfunctional monomers is preferably 1% by mass or more and 20% by mass or less, more preferably 2% by mass or more and 15% by mass or less, still more preferably 4% by mass or more and 10% by mass or less, and even still more preferably 5% by mass or more and 9% by mass or less with respect to the total amount of the polymerizable compounds. By setting the content of the trifunctional or higher polyfunctional monomers within the range, the blocking resistance, the adhesion, and the shrinkage characteristics are improved.

The content of the trifunctional or higher polyfunctional monomers is more than 1% by mass, preferably 3% by mass or more, more preferably 3.5% by mass or more, and still more preferably 4% by mass or more with respect to the total amount of the ink composition. By setting the content of the trifunctional or higher polyfunctional monomers within the range, the blocking resistance tends to be further improved. In addition, the content of the trifunctional or higher polyfunctional monomers is preferably 10% by mass or less, more preferably 9% by mass or less, and still more preferably 7% by mass or less with respect to the total amount of the ink composition. By setting the content of the trifunctional or higher polyfunctional monomers within the range, the viscosity tends to be more readily within a suitable range and the shrinkage characteristics tend to be further improved.

### 1.2. Polymerization Inhibitor

In the present embodiment, the ink composition may include a polymerization inhibitor. The polymerization inhibitor is not particularly limited, but examples thereof include phenol compounds, quinone compounds, amine compounds, nitro compounds, oxime compounds, sulfur compounds, and oxyl compounds. These polymerization inhibitors are used alone or in combination of two or more kinds thereof.

The phenol compound is not particularly limited, but examples thereof include p-methoxyphenol, cresol, tert-butylcatechol, di-tert-butyl-para-cresol, hydroquinone monomethyl ether, α-naphthol, 3,5-di-tert-butyl-4-hydroxytoluene, 2,2′-methylenebis(4-methyl-6-tert-butylphenol), 2,2′-methylenebis(4-ethyl-6-butylphenol), and 4,4′-thiobis(3-methyl-6-tert-butylphenol). Examples of commercially available products of the phenol compound include MEHQ (p-methoxyphenol, manufactured by Kanto Chemical Co., Inc.).

The quinone compound is not particularly limited, but examples thereof include p-benzoquinone, anthraquinone, naphthoquinone, phenanthraquinone, p-xyloquinone, p-toluquinone, 2,6-dichloroquinone, 2,5-diphenyl-p-benzoquinone, 2,5-diacetoxy-p-benzoquinone, 2,5-dicaproxy-p-benzoquinone, 2,5-diacyloxy-p-benzoquinone, hydroquinone, 2,5-di-butylhydroquinone, mono-tert-butylhydroquinone, monomethylhydroquinone, and 2,5-di-tert-amylhydroquinone.

The amine compound is not particularly limited, but examples thereof include phenyl-B-naphthylamine, p-benzylaminophenol, di-B-naphthyl-para-phenylenediamine, dibenzylhydroxylamine, phenylhydroxylamine, diethylhydroxylamine, a compound having a 2,2,6,6-tetramethylpiperidine skeleton, a compound having a 2,2,6,6-tetramethylpiperidine-N-alkyl skeleton, and a compound having a 2,2,6,6-tetramethylpiperidine-N-acyl skeleton.

The nitro compound is not particularly limited, but examples thereof include dinitrobenzene, trinitrotoluene, picric acid, and derivatives thereof. The oxime compound is not particularly limited, but examples thereof include quinone dioxime and cyclohexanone oxime. The sulfur compound is not particularly limited, but examples thereof include phenothiazine.

The oxyl compound is not particularly limited, but examples thereof include derivatives of 2,2,6,6-tetramethylpiperidinyl-1-oxyl. Examples of the derivatives of 2,2,6,6-tetramethylpiperidinyl-1-oxyl include 4-acetamido-2,2,6,6-tetramethylpiperidinyl-1-oxyl, 4-amino-2,2,6,6-tetramethylpiperidinyl-1-oxyl, 4-carboxy-2,2,6,6-tetramethylpiperidinyl-1-oxyl, 4-(2-chloroacetamido)-2,2,6,6-tetramethylpiperidinyl-1-oxyl, 4-cyano-2,2,6,6-tetramethylpiperidinyl-1-oxyl, 4-hydroxy-2,2,6,6-tetramethylpiperidinyl-1-oxyl, 4-hydroxybenzoate-2,2,6,6-tetramethylpiperidinyl-1-oxyl, 4-(2-iodoacetamido)-2,2,6,6-tetramethylpiperidinyl-1-oxyl, 4-isothiocyanato-2,2,6,6-tetramethylpiperidinyl-1-oxyl, 4-methacryloyloxy-2,2,6,6-tetramethylpiperidinyl-1-oxyl, 4-methoxy-2,2,6,6-tetramethylpiperidinyl-1-oxyl, 4-oxo-2,2,6,6-tetramethylpiperidinyl-1-oxyl, and 4-(2-propynyloxy)-2,2,6,6-tetramethylpiperidinyl-1-oxyl. Examples of commercially available products of the oxyl compound include ADK STAB LA-7RD (2,2,6,6-tetramethyl-4-hydroxypiperidin-1-oxyl, product name, manufactured by ADEKA Corporation).

The content of the polymerization inhibitor is preferably 0.01% by mass or more and 5.0% by mass or less, more preferably 0.05% by mass or more and 3.0% by mass or less, and still more preferably 0.1% by mass or more and 1.0% by mass or less with respect to the total amount of the ink composition. By setting the content of the polymerization inhibitor within the range, the blocking resistance, the adhesion, the tackiness, and the shrinkage characteristics tend to be further improved.

### 1.3. Polymerization Initiator

In the present embodiment, the ink composition may include a polymerization initiator. The polymerization initiator is not particularly limited as long as it generates active species by irradiation with radiation, but examples thereof include known polymerization initiators such as acyl phosphine oxide-based polymerization initiators, alkylphenone-based polymerization initiators, titanocene-based polymerization initiators, and thioxanthone-based polymerization initiators. Among these, the polymerization initiator preferably includes the acyl phosphine oxide-based polymerization initiators and the thioxanthone-based polymerization initiators, and more preferably includes the thioxanthone-based polymerization initiators. By using such polymerization initiators, the curability of the composition tends to be further improved, and in particular, the curability by the curing process with an ultraviolet light emitting diode tends to be further improved, and therefore, the blocking resistance and the tackiness are improved. These polymerization initiators are used alone or in combination of two or more kinds thereof.

The content of the polymerization initiator is preferably 3% by mass or more and 17% by mass or less, more preferably 5% by mass or more and 15% by mass or less, and still more preferably 7% by mass or more and 12% by mass or less with respect to the total amount of the ink composition. By setting the content of the polymerization initiator within the range, the blocking resistance, the adhesion, the tackiness, and the shrinkage characteristics tend to be further improved.

### 1.3.1. Acyl Phosphine Oxide-Based Polymerization Initiators

The acyl phosphine oxide-based polymerization initiators are not particularly limited, but examples thereof include 2,4,6-trimethylbenzoyldiphenylphosphine oxide, bis(2,4,6-trimethylbenzoyl)-phenylphosphine oxide, and bis(2,6-dimethoxybenzoyl)-2,4,4-trimethylpentylphosphine oxide. These acyl phosphine oxide-based polymerization initiators may be used alone or in combination of two or more kinds thereof.

Examples of commercially available products of the acyl phosphine oxide-based polymerization initiators include Omnirad 819 (bis(2,4,6-trimethylbenzoyl)phenylphosphine oxide, product name, manufactured by IGM Resins B. V.) and Omnirad TPO-L (ethyl(2,4,6-trimethylbenzoyl)-phenylphosphinate, product name, manufactured by IGM Resins B. V.).

The content of the acyl phosphine oxide-based polymerization initiators is preferably 0.1% by mass or more and 20% by mass or less, more preferably 1% by mass or more and 15% by mass or less, still more preferably 3% by mass or more and 10% by mass or less, and even still more preferably 5% by mass or more and 7% by mass or less with respect to the total amount of the ink composition. By setting the content of the acyl phosphine oxide-based polymerization initiators within the range, the blocking resistance, the adhesion, the tackiness, and the shrinkage characteristics tend to be further improved.

### 1.3.2. Thioxanthone-Based Polymerization Initiators

The thioxanthone-based polymerization initiators are not particularly limited, but examples thereof include low-molecular-weight thioxanthone initiators and high-molecular-weight thioxanthone initiators. Furthermore, in the present embodiment, the “low-molecular-weight thioxanthone initiators” are thioxanthone-based polymerization initiators having a molecular weight of less than 500, and the “high-molecular-weight thioxanthone initiators” are thioxanthone-based polymerization initiators having a molecular weight of 500 or more. The thioxanthone-based polymerization initiators are preferably high-molecular-weight thioxanthone initiators. By using the high-molecular-weight thioxanthone initiators, the odor can be further reduced and the odor is less likely to transfer to a container or the like having a shrink film, and therefore, the high-molecular-weight thioxanthone initiators are more suitable for shrink film applications. The thioxanthone-based polymerization initiators are used alone or in combination of two or more kinds thereof.

The low-molecular-weight thioxanthone initiators are not particularly limited, but examples thereof include thioxanthone, 2-methylthioxanthone, 2,4-diethylthioxanthone, 2-isopropylthioxanthone, 4-isopropylthioxanthone, and 2-chlorothioxanthone. Examples of commercially available products of the low-molecular-weight thioxanthone initiators include Speedcure DETX (2,4-diethylthioxanthen-9-one, manufactured by Lambson Ltd.).

The high-molecular-weight thioxanthone initiators are not particularly limited, but examples thereof include 1,3-di({α-[1-chloro-9-oxo-9H-thioxanthen-4-yl]oxy}acetyl poly[oxy(1-methylethylene)]oxy)-2,2-bis({α-[1-chloro-9-oxo-9H-thioxanthen-4-yl]oxy}acetyl poly[oxy(1-methylethylene)]oxymethyl)propane and α-[2-[(9-oxo-9H-thioxanthenyl)oxy]acetyl]-ω-[[2-[(9-oxo-9H-thioxanthenyl)oxy]acetyl]oxy]poly(oxy-1,4-butanediyl). The high-molecular-weight thioxanthone initiators may be commercially available products, and examples thereof include SPEEDCURE 7010 (thioxanthone polymer type, manufactured by Lambson Ltd.), and Omnipol (registered trademark) TX (product name, manufactured by IGM RESINS).

The content of the thioxanthone-based polymerization initiators is preferably 0.1% by mass or more and 10% by mass or less, more preferably 1% by mass or more and 5% by mass or less, and still more preferably 2% by mass or more and 4% by mass or less with respect to the total amount of the ink composition. By setting the content of the thioxanthone-based polymerization initiators within the range, the blocking resistance, the adhesion, the tackiness, and the shrinkage characteristics tend to be further improved.

### 1.4. Surfactant

In the present embodiment, the ink composition may include a surfactant. Examples of the surfactant include acetylene glycol-based surfactants, fluorine-based surfactants, and silicone-based surfactants. These surfactants are used alone or in combination of two or more kinds thereof.

The acetylene glycol-based surfactants are not particularly limited, but examples thereof include 2,4,7,9-tetramethyl-5-decyne-4,7-diol, and an alkylene oxide adduct of 2,4,7,9-tetramethyl-5-decyne-4,7-diol. Examples of commercially available products of the acetylene glycol-based surfactants include SURFYNOL 465 (product name, manufactured by Nisshin Chemical Industry Co., Ltd.).

The fluorine-based surfactants are not particularly limited, but examples thereof include perfluoroalkyl sulfonates, perfluoroalkyl carboxylates, perfluoroalkyl phosphates, perfluoroalkyl ethylene oxide adducts, perfluoroalkyl betaines, and perfluoroalkylamine oxide compounds.

The silicone-based surfactants are not particularly limited, but examples thereof include polysiloxane-based compounds and polyether-modified organosiloxanes. Examples of commercially available products of the silicone-based surfactants include BYK-306, BYK-307, BYK-333, BYK-341, BYK-345, BYK-346, BYK-348, BYK-UV3500, BYK-UV3510, BYK-UV3530, and BYK-UV3570 (product names, manufactured by BYK).

The content of the surfactants is preferably 0.01% by mass or more and 5% by mass or less, more preferably 0.1% by mass or more and 3% by mass or less, and still more preferably 0.3% by mass or more and 1% by mass or less with respect to the total amount of the ink composition. By setting the content of the surfactant within the range, the blocking resistance, the adhesion, the tackiness, and the shrinkage characteristics tend to be further improved.

### 1.5. Dispersant

The ink composition of the present embodiment may include a dispersant. The dispersant is not particularly limited, but examples thereof include dispersants that are commonly used to prepare pigment dispersion liquids such as polymeric dispersants. Specific examples of the dispersant include polyoxyalkylene, polyalkylene polyamines, vinyl-based polymers and copolymers, acrylic-based polymers and copolymers, polyesters, polyamides, polyimides, polyurethane, amino-based polymers, silicon-containing polymers, sulfur-containing polymers, fluorine-containing polymers, and epoxy resins. These dispersants are used alone or in combination of two or more kinds thereof.

The dispersant may be a commercially available product, and examples thereof include Ajisper series (manufactured by Ajinomoto Fine-Techno Co., Inc.), Solsperse 36000 (a product name by Noveon), Disperbyk series (manufactured by BYK), and Disparlon series (manufactured by Kusumoto Chemicals, Ltd.).

The content of the dispersant is preferably 0.01% by mass or more and 5% by mass or less, more preferably 0.05% by mass or more and 1% by mass or less, and still more preferably 0.1% by mass or more and 0.5% by mass or less with respect to the total amount of the ink composition. By setting the content of the dispersant within the range, the blocking resistance, the adhesion, the tackiness, and the shrinkage characteristics tend to be further improved.

### 1.6. Coloring Material

The ink composition of the present embodiment may include a coloring material. The coloring material may be either a pigment or a dye. The pigment is not particularly limited, but examples thereof include organic pigments and inorganic pigments. These coloring materials are used alone or in combination of two or more kinds thereof.

Examples of the organic pigments include azo pigments such as an azo lake pigment, an insoluble monoazo pigment, an insoluble disazo pigment, a condensed azo pigment, and a chelate azo pigment; polycyclic pigments such as a phthalocyanine pigment, a quinacridone pigment, a perylene pigment, a perinone pigment, an anthraquinone pigment, a dioxazine pigment, a thioindigo pigment, an isoindolinone pigment, and a quinophthalone pigment; dye chelates such as a basic dye-type chelate and an acid dye-type chelate; and nitro pigments and nitroso pigments.

Examples of the inorganic pigment include titanium dioxide, yellow iron oxide, brown iron oxide, chromium oxide, Prussian blue, ultramarine blue, molybdenum red, black iron oxide, lead chromate, complex oxide pigments, and carbon black.

Examples of the carbon black include Colour Index Generic Name (C. I.) Pigment Black 1, 7, and 11. Examples of commercially available products of the carbon black include No. 2300, No. 900, MCF88, No. 33, No. 40, No. 45, No. 52, MA7, MA8, MA100, and No. 2200B (product names, manufactured by Mitsubishi Chemical Corporation), Raven 5750, 5250, 5000, 3500, 1255, and 700 (product names, manufactured by Columbia Carbon Inc.), Regal 400R, 330R, 660R, Mogul L, Monarch 700, 800, 880, 900, 1000, 1100, 1300, and 1400 (product names, manufactured by Cabot Corporation), and Color Black FW1, FW2, FW2V, FW18, FW200, S150, S160, S170, Printex 35, U, V, 140U, Special Black 6, 5, 4A, and 4 (product names, manufactured by Degussa Corporation). The carbon black produced by a known method such as a contact method, a furnace method, or a thermal method may be used.

The dyes are not particularly limited, but examples thereof include acid dyes, direct dyes, reactive dyes, and basic dyes. Specific examples of the dyes include C. I. Acid Yellow 17, 23, 42, 44, 79, and 142, C. I. Acid Red 52, 80, 82, 249, 254, and 289, C. I. Acid Blue 9, 45, and 249, C. I. Acid Black 1, 2, 24, and 94, C. I. Food Black 1 and 2, C. I. Direct Yellow 1, 12, 24, 33, and 50, C. I. Direct Red 1, 4, 9, 80, 81, 225, and 227, C. I. Direct Blue 1, 2, 15, 71, 86, 87, and 98, C. I. Direct Black 19, 38, 51, 71, and 154, C. I. Reactive Red 14, 32, 55, 79, and 249, and C. I. Reactive Black 3, 4, and 35.

The content of the coloring material is preferably 0.1% by mass or more and 10% by mass or less, more preferably 1% by mass or more and 5% by mass or less, and still more preferably 2% by mass or more and 4% by mass or less with respect to the total amount of the ink composition. By setting the content of the coloring material within the range, the blocking resistance, tackiness, the adhesion, and the shrinkage characteristics tend to be further improved.

### 1.7. Other Components

As components other than those described above, for example, various additives such as a chelating agent, a softening agent, a dissolution aid, a viscosity adjusting agent, an ultraviolet absorbing agent, an antioxidant, and a corrosion inhibitor may be contained as necessary.

### 2. Method for Preparing Ink Composition

With regard to a method for preparing the ink composition, the ink composition can be prepared, for example, by mixing each of components in any order and performing filtration or the like as necessary to remove impurities, foreign substances, and the like. As a method for mixing each of the components, a method of sequentially introducing each of the components into a container equipped with a stirring device such as a mechanical stirrer or a magnetic stirrer, and performing stirring and mixing, is used. Examples of the filtration method include centrifugal filtration and filter filtration.

### 3. Recording Medium

As the recording medium of the present embodiment, for example, paper, a film, a cloth, a metal, or glass can be used. Among these, the film is preferably used as a shrink film or a flexible packaging film. Since the shrink film and the flexible packaging film are often shrunk or bent, the effect of the present embodiment is remarkable. The shrink film is not particularly limited, but examples thereof include a film having a property of at least shrinking in one direction upon heating. In the present embodiment, the flexible packaging film is a flexible film material used for packaging food, toiletries, cosmetics, and the like. The material of the shrink film preferably includes one or more selected from polyethylene terephthalate, polyethylene, polyolefin, polystyrene, polypropylene, and polyvinyl chloride, and thus tends to be excellent in shrinkage characteristics.

### 4. Recording Method

The ink jet recording method according to the present embodiment includes an attachment step of discharging the radiation-curable ink jet composition from an ink jet head to attach the radiation-curable ink jet composition to a shrink film or a flexible packaging film, and a step of irradiating, with radiation, the radiation-curable ink jet composition attached. Since the shrink film and the flexible packaging film are often shrunk or bent, the effect of the present embodiment is remarkable.

### 4.1. Attachment Step

In the attachment step, the heated ink composition is discharged from the ink jet head and attached to a shrink film or a flexible packaging film. More specifically, a pressure generating unit is driven to discharge the ink composition filled in a pressure generating chamber of the ink jet head through nozzles. Such a discharge method is also referred to as an ink jet method.

Examples of the ink jet head used in the attachment step include a line head that performs recording in a line method and a serial head that performs recording in a serial method.

In the line method using the line head, for example, a liquid discharging head having a width equal to or larger than a recording width of a recording medium is fixed to the ink jet apparatus. Then, the recording medium is moved along a sub-scanning direction (the vertical direction of the recording medium, a transport direction), ink droplets are discharged from the nozzles of the ink jet head in conjunction with the movement, whereby an image is recorded on the recording medium.

In the serial method using the serial head, for example, an ink jet head is mounted on a carriage that can move in a width direction of a recording medium. Then, the carriage is moved along a main scanning direction (the lateral direction or width direction of the recording medium), and ink droplets are discharged from nozzle openings of the head in conjunction with the movement, whereby an image can be recorded on the recording medium.

### 4.2. Irradiation Step

In the irradiation step, the radiation-curable ink jet composition attached to the recording medium is irradiated with radiation. When the irradiation with radiation is performed, the ink composition is cured by the initiation of a polymerization reaction of the polymerizable compounds, and a coating film is formed. At this time, when the polymerization initiator is present, active species (initiating species) such as radicals, acids, and bases are generated, and the polymerization reaction of the polymerizable compounds is accelerated by the function of the initiating species.

Here, examples of the radiation include ultraviolet rays, infrared rays, visible light, and X-rays. The ink composition is irradiated with the radiation by a radiation source provided downstream of the ink jet head. The radiation source is not particularly limited, but examples thereof include an ultraviolet light emitting diode. By using such a radiation source, miniaturization of the apparatus and cost reduction can be achieved. The ultraviolet light emitting diode as the ultraviolet light source is small, and can thus be attached to the ink jet apparatus. For example, the ultraviolet light emitting diode can be attached to a carriage (at both ends along the medium width direction and/or on the medium transport direction side) on which an ink jet head discharging the radiation-curable ink jet composition is mounted.

### 5. Ink Jet Apparatus

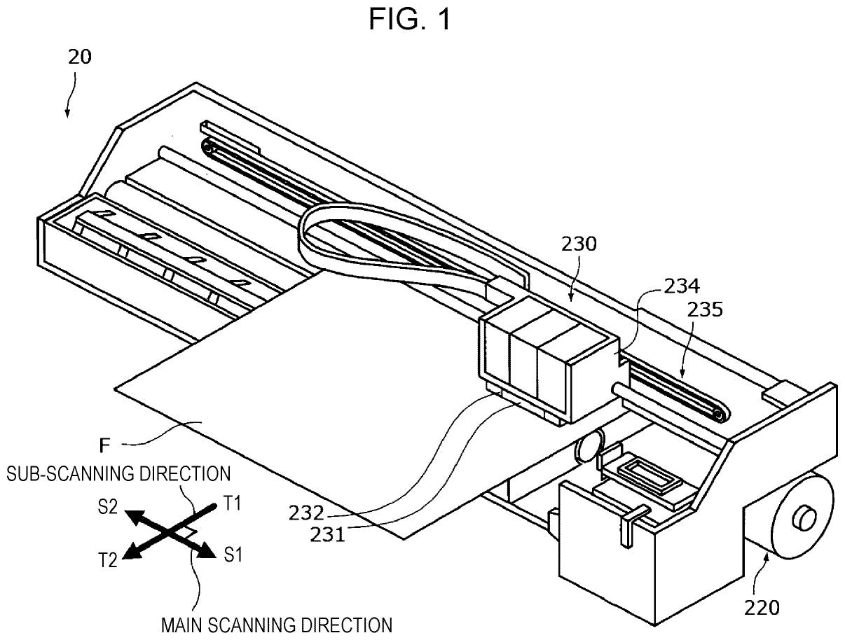

The ink jet apparatus of the present embodiment is not particularly limited as long as it includes an ink jet head having nozzles that discharge the above-described ink composition to a recording medium, and a radiation source that irradiates the discharged ink composition with radiation. As an example of the ink jet apparatus, a perspective view of a serial printer is shown in FIG. 1. As shown in FIG. 1, a serial printer 20 is provided with a transport portion 220 and a recording portion 230. The transport portion 220 transports a recording medium F fed to the serial printer to the recording portion 230, and discharges the recording medium after recording to the outside of the serial printer. Specifically, the transport portion 220 includes each feeding roller and transports the fed recording medium F in a sub-scanning direction Ti.

In addition, the recording portion 230 includes an ink jet head 231 that discharges an ink composition to the recording medium F fed from the transport portion 220, a radiation source 232 that irradiates the attached ink composition with radiation, a carriage 234 on which these are mounted, and a carriage movement mechanism 235 that moves the carriage 234 in the main scanning directions S1 and S2 of the recording medium F.

With regard to the serial printer, the ink jet head 231 has a length smaller than the width of the recording medium, the ink jet head 231 moves, and the recording is performed in a plurality of passes (multi-pass). In addition, in the serial printer, the ink jet head 231 and the radiation source 232 are mounted on a carriage 234 that moves in a predetermined direction, and the ink composition is discharged onto a recording medium by moving the ink jet head 231 along with the movement of the carriage. As a result, the recording is performed in two or more passes (multi-pass). Furthermore, the passes are also referred to as main scanning. Sub-scanning in which the recording medium is transported between the passes is performed. That is, the main scanning and the sub-scanning are alternately performed.

Furthermore, although an aspect in which the radiation source is mounted on the carriage is illustrated in FIG. 1, the present disclosure is not limited thereto, and the radiation source may not be mounted on the carriage.

In addition, the ink jet apparatus of the present embodiment is not limited to the serial type printer and may be the above-described line type printer.

### EXAMPLES

Hereinafter, the present disclosure will be described in more detail with reference to Examples and Comparative Examples. The present disclosure is not limited by the following Examples.

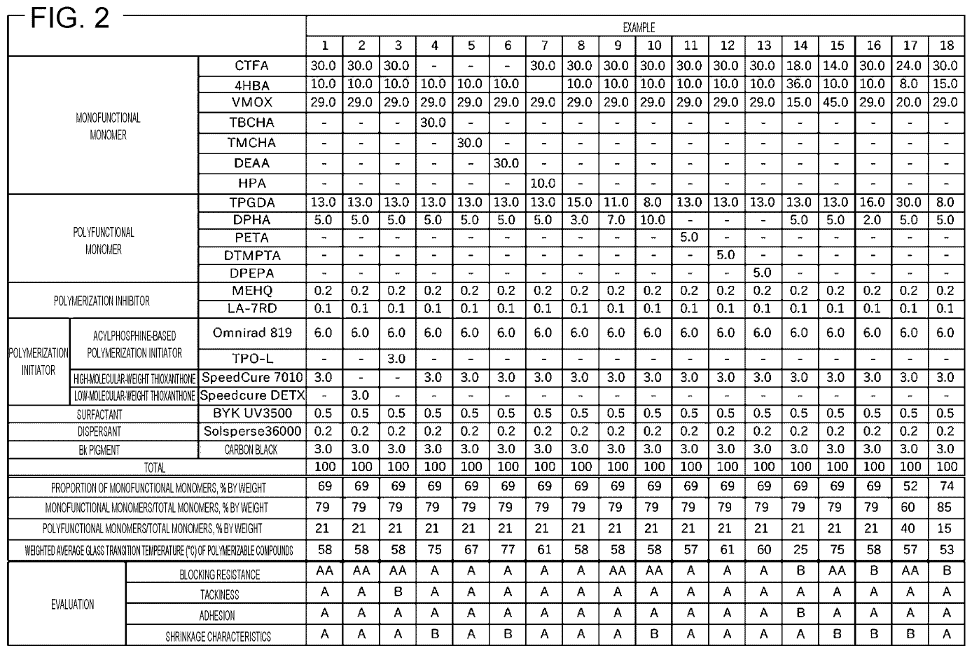

In FIG. 2, Table 1 showing the configuration of each of the compositions of Examples and Comparative Examples is described.

### 1. Preparation of Each Composition

An ink composition of each example was obtained by putting each of the components into a tank for a mixture to provide the composition described in Table 1, mixing and stirring the components, and further filtering the components with a membrane filter. Furthermore, the numerical value of each of the components shown in each example in the table represents % by mass unless otherwise specified. In addition, in the table, the numerical value of each content represents % by mass of the solid content of the active component.

The details of the abbreviations and product components used in a treatment liquid composition are as follows.

### Monofunctional Monomers

Cyclic trimethylolpropane formal acrylate (CTFA)
4-Hydroxybutyl acrylate (4HBA)
5-Methyl-3-vinyloxazolidin-2-one (VMOX)
4-tert-Butylcyclohexyl acrylate (TBCHA)
3,3,5-Trimethylcyclohexyl acrylate (TMCHA)
N,N-Diethyl acrylamide (DEAA)
Hydroxypropyl acrylate (HPA)

### Polyfunctional Monomers

Tripropylene glycol diacrylate (TPGDA)
Dipentaerythritol hexaacrylate (DPHA)
Pentaerythritol triacrylate (PETA)
Ditrimethylolpropane tetraacrylate (DTMPTA)
Dipentaerythritol pentaacrylate (DPEPA)

### Polymerization Inhibitor

MEHQ (p-Methoxyphenol, manufactured by Kanto Chemical Co., Inc.)
LA-7RD (Product name “ADK STAB LA-7RD”, 4-hydroxy-2,2,6,6-tetramethylpiperidinyl-1-oxyl, manufactured by ADEKA Corporation)

### Polymerization Initiator

Omnirad 819 (Bis(2,4,6-trimethylbenzoyl)phenylphosphine oxide, product name, manufactured by IGM Resins B. V.)
TPO-L (Product name “Omnirad TPO-L”, ethyl(2,4,6-trimethylbenzoyl)-phenylphosphinate, manufactured by IGM Resins B. V.)
Speedcure 7010 (1,3-di({α-[1-chloro-9-oxo-9H-thioxanthen-4-yl]oxy}acetyl poly[oxy(1-methylethylene)]oxy)-2,2-bis({α-[1-chloro-9-oxo-9H-thioxanthen-4-yl]oxy}acetyl poly[oxy(1-methylethylene)]oxymethyl)propane; product name, manufactured by Lambson Ltd., molecular weight: 1,839)
Speedcure DETX (2,4-Diethylthioxanthen-9-one, product name, manufactured by Lambson Ltd., molecular weight: 268) Surfactant
BYK UV3500 (Silicone-based surfactant, product name, manufactured by BYK)

### Dispersant

Solsperse 36000 (polymeric dispersant, product name, manufactured by Lubrizol Corporation)

### Pigment

Carbon black

### Water

Pure water

### 2. Evaluation Method

3.1. Blocking resistance

### Manufacture of Packaging Body

A sample for evaluating the blocking resistance is created using an ink jet printer “PX-G5000” (product name, manufactured by Seiko Epson Corporation). A printing sample having a film thickness of 5 μm is obtained by printing a solid pattern image on a PET film “BONSET” (product name, manufactured by Takiron Co., Ltd.), which is a recording medium, under conditions of a recording resolution of 600 dpi×600 dpi and a droplet weight of 10 ng, at room temperature and normal pressure. Furthermore, the solid pattern image is an image in which dots are recorded for all pixels each indicating a minimum recording unit region defined by the recording resolution. With the printing being performed, ultraviolet rays are irradiated from an ultraviolet light emitting diode in an ultraviolet irradiation apparatus mounted beside the carriage to obtain a recorded material, in which a cured film of the ink composition having a film thickness of 5 μm is formed on the recording medium.

The recorded material obtained as described above is rolled with the cured film facing inward and processed into a cylindrical shape. The recorded material is disposed around a container (glass bottle) which is a packaging body preheated in a thermostat bath, and is allowed to stand for 10 seconds in the thermostat bath at 90° C. to cause the recorded material to shrink and adhere to the container.

### Measurement of Blocking Resistance

The packaging body manufactured above is visually observed to determine whether or not the cured film adheres to the container, the presence or absence of adhesion is evaluated in accordance with the following evaluation criteria, and the blocking resistance is evaluated.

### Evaluation Criteria

A: No adhesion of the cured film to the container
B: Slight adhesion of the cured film to the container
C: Adhesion of the cured film to the container (occurrence of peeling)

### 3.2. Tackiness

The ink composition is applied onto a PET film with a bar coater so that the film thickness of the cured film is 5 μm. Irradiation is performed with an ultraviolet light emitting diode (peak wavelength of 395 nm, irradiation intensity of 1,000 mW/cm²), and the irradiation energy is obtained by irradiating until reaching a tack-free state. The irradiation energy [mJ/cm²] is determined by measuring the irradiation intensity [mW/cm²] on the irradiation surface irradiated from the light source and determining a product of the irradiation intensity and the irradiation continuation time [s]. The measurement of the irradiation intensity is performed using an ultraviolet intensity meter UM-10 and a light receiving portion UM-400 (both manufactured by Konica Minolta Sensing, Inc.). In addition, whether or not the state is a tack-free state is judged based on the following conditions. That is, the effect film is rubbed with a cotton swab, and the judgment is made based on whether or not the ink adheres to the cotton swab or the ink cured product on the recording medium is scratched. At that time, the cotton swab used is a Johnson cotton swab manufactured by Johnson & Johnson. The number of times of rubbing is set to 10 times back and forth, and the rubbing force is set to a 100 g load.

The tackiness is evaluated in accordance with the following evaluation criteria, based on the irradiation energy (tack-free energy) at which a tack-free state is achieved.

### Evaluation Criteria

AA: The tack-free energy is less than 150 mJ/cm²
A: The tack-free energy is 150 mJ/cm² or more and less than 250 mJ/cm²
B: The tack-free energy is 250 mJ/cm² or more and less than 350 mJ/cm²
C: The tack-free energy is 350 mJ/cm² or more

### 3.3. Adhesion

The adhesion of the recorded material created in the evaluation of the tackiness is evaluated by a cross-cut test in accordance with JIS K5600-5-6. That is, the obtained effect film is cut with a cutter to make grid-like cuts of 10×10 squares with a distance between the cuts being 1 mm, with the blade of the cutting tool being placed perpendicular to the coating film. A transparent adhesive tape is attached to the cut area, and the tape is sufficiently rubbed with a finger so that the cured film can be seen through the tape. Next, within 5 minutes after the tape is attached, the tape is peeled off from the cured film at an angle close to 60° in 0.5 to 1.0 seconds. At this time, the peeling of the cured film from the film is visually observed for each square of the grid based on the presence or absence of the peeling. The adhesion is evaluated in accordance with the following evaluation criteria.

### Evaluation Criteria

A: The peeling of the cured film is observed in less than 20% of the grid.

B: The peeling of the cured film is observed in 20% or more and less than 30% of the grid.

C: The peeling of the cured film is observed in 30% or more of the grid.

### 3.4. Shrinkage Characteristics

In the packaging body manufactured in the evaluation of the blocking resistance, the occurrence situation of wrinkles before and after shrinkage is visually observed, and the shrinkage characteristics are evaluated in accordance with the following evaluation criteria.

### Evaluation Criteria

A: No wrinkles in the cured film
B: Slight wrinkles in the cured film
C: Wrinkles in the cured film

### 4. Evaluation Results

From Tables 1 and 2, it can be seen that the radiation-curable ink jet ink composition of the present embodiment has excellent blocking resistance, adhesion, tackiness, and shrinkage characteristics.

What is claimed is:

1. A radiation-curable ink jet ink composition comprising:
trifunctional or higher polyfunctional monomers; and
5-methyl-3-vinyloxazolidin-2-one, wherein
a content of the 5-methyl-3-vinyloxazolidin-2-one is less than 50% by mass with respect to a total amount of the radiation-curable ink jet ink composition,
a content of monofunctional monomers is 60% by mass or more with respect to a total amount of polymerizable compounds, and
a content of the trifunctional or higher polyfunctional monomers is more than 1% by mass with respect to the total amount of the radiation-curable ink jet ink composition.

2. The radiation-curable ink jet ink composition according to claim 1, wherein
the content of the trifunctional or higher polyfunctional monomers is 3% by mass or more and 10% by mass or less with respect to the total amount of the radiation-curable ink jet ink composition.

3. The radiation-curable ink jet ink composition according to claim 1, wherein
the trifunctional or higher polyfunctional monomer has three or more acrylic groups.

4. The radiation-curable ink jet ink composition according to claim 1, wherein
an acrylic equivalent of the trifunctional or higher polyfunctional monomer is 110 g/eq or less.

5. The radiation-curable ink jet ink composition according to claim 1, wherein
the trifunctional or higher polyfunctional monomers include one or more selected from the group consisting of dipentaerythritol hexaacrylate, pentaerythritol triacrylate, ditrimethylolpropane tetraacrylate, and dipentaerythritol pentaacrylate.

6. The radiation-curable ink jet ink composition according to claim 1, further comprising
ether cyclic monofunctional monomers.

7. The radiation-curable ink jet ink composition according to claim 1, further comprising
monofunctional monomers having a hydroxyl group.

8. The radiation-curable ink jet ink composition according to claim 1, wherein
a weighted average glass transition temperature of the polymerizable compounds is 30° C. or higher and 70° C. or lower.

9. The radiation-curable ink jet ink composition according to claim 1, further comprising
a polymeric thioxanthone initiator.

10. The radiation-curable ink jet ink composition according to claim 1, wherein
the content of the 5-methyl-3-vinyloxazolidin-2-one is 10% by mass or more with respect to the total amount of the radiation-curable ink jet ink composition.

11. The radiation-curable ink jet ink composition according to claim 1, wherein
when a difference between a highest glass transition temperature and a lowest glass transition temperature among glass transition temperatures of homopolymers of the monofunctional monomers is defined as a difference A [° C.], and
a difference between a highest glass transition temperature and a lowest glass transition temperature among glass transition temperatures of homopolymers of the polyfunctional monomers included in the radiation-curable ink jet ink composition is defined as a difference B [° C.],
the difference A [° C.] is larger than the difference B [° C.].

12. The radiation-curable ink jet ink composition according to claim 1, wherein
the radiation-curable ink jet ink composition is to be attached to a shrink film and/or a flexible packaging film.

13. A recording method comprising:
discharging the radiation-curable ink jet ink composition according to claim 1 from an ink jet head to attach the radiation-curable ink jet ink composition to a shrink film or a flexible packaging film; and
irradiating, with radiation, the radiation-curable ink jet ink composition attached.
